(19) United States
(12) Patent Application Publication
(10) Pub. No.: US 2005/0037513 A1
(43) Pub. Date: Feb. 17, 2005

(54) PCB sampler

(76) Inventors: William A. Ivancic, Gahanna, OH (US); Jane C. Chuang, Columbus, OH (US); Anthony S. Wisbith, Granville, OH (US); Heather G. Kitchen, Columbus, OH (US); Bradley B. Ross, Granville, OH (US); Karen L. Tracy, Columbus, OH (US); George W. Keigley, Columbus, OH (US); Jan B. Yates, Reynoldsburg, OH (US)

Correspondence Address: BATTELLE MEMORIAL INSTITUTE, 505 KING AVENUE, COLUMBUS, OH, 43201-2693, US

(21) Appl. No.: 10/814,376

(22) Filed: Mar. 31, 2004

Related U.S. Application Data
(60) Provisional application No. 60/459,378, filed on Mar. 31, 2003.
(60) Provisional application No. 60/460,743, filed on Jul. 1, 2003.

(51) Int. Cl. G01N 1/00

(52) U.S. Cl. 436/171; 436/174; 422/99

(57) ABSTRACT

The apparatus includes a laser to vaporize or break down an analyte desired to be measured (e.g. PCB or PCB like compounds) in a surface area. The analyte is vaporized and transported to an absorption trap for analysis. Typically the system is sufficiently portable to take to a site and acquire samples for analysis on site. The analytes can be analyzed directly from the absorption trap without solvent extraction processes. Typically the system is portable allowing acquisition and analysis on site.

### FIELD OF THE INVENTION

A real-time PCB monitor consisting of a laser-induced vaporization and sampling cartridges coupling with a mobile GCMS system for determining PCBs on painted surfaces. The PCB monitor will be employed in the field for real-time determination and confirmation of the presence of PCBs in surfaces, especially painted surfaces. This can eliminate the need and cost of sending samples to analytical laboratories for presence confirmation. The monitor is particularly useful in remote locations.

### BACKGROUND OF THE INVENTION

In 1989 the Navy discovered during the course of normal occupational safety work at a shipyard that PCBs occurred in many plastics, rubbers, adhesives, gaskets and other commercial non-metal products used in Navy Ships. In the early 1990's the Navy initiated a sampling program for PCBs in ships. At that time it was discovered that much of the MIL-spec paint used on ships contained PCB, added as a plasticizer and flame retardant. Further investigation found paint containing PCBs in many non-Navy facilities and structures.

DoD components, the Navy, the Air Force, the Army, the Marines and the Coast Guard use common specifications for paints on vehicles. The MIL Specs are not differentiated by service. It is highly possible (very likely) that vehicles, facilities and structures of the other services may also contain PCB. In 1989 work also began, directed toward development of an international treaty that would ban the use of PCB and nine other chemicals in paint. Some of these other nine chemicals may also be present in mil-spec paint and commercial structures such as bridges, towers and other structures that require protective paint. It was found that the magnitude of the problem for just PCB contamination was very large.

### BRIEF DESCRIPTION OF THE INVENTION

Broadly, the invention herein discloses apparatus that includes the use a laser to vaporize any analytes such as, but not limited to, PCB or PCB like compounds in a surface sample, the vapor is transported to a detection area and tested. Typically the system is sufficiently portable to take to a site and acquire samples for analysis on site.

### BRIEF DESCRIPTION OF THE DRAWINGS

FIG. 1 is a schematic drawing illustrating one typical embodiment of the invention.

FIGS. 2A, 2B, 2C, 2D, 2E, and 2F are various views of the body (or in some embodiments a portion of a typical frame.

FIGS. 3A and 3B are GC plots of the observation of PCB from Example 6 in which the cold trap was used.

FIGS. 4A and 4B show a GC plot for the observation of PCB.

FIGS. 5A and 5B show two chromatographs of Example 7

FIG. 6 shows a chromatographic pattern of Arochlor 1254.

FIGS. 7A and 7B show the calibration pattern (left) as compared to the observed pattern on Sample 1(right).

FIGS. 8A and 8B show a comparison of mass spectrometry results at a retention time of 41.5 minutes.

FIG. 9 is a schematic diagram showing another embodiment of the invention.

FIG. 10 is a depiction of the collection head held against a surface and positioned to collect a sample.

FIG. 11 is a depiction of a typical desorber measurement unit.

FIG. 12 is a schematic drawing of the mirror assembly for the sample head. Laser light enters from the bottom from a optical fiber and interface into a lens and then onto the mirror the light is then focused onto a target. Typically the mirror is controlled to scan a selected area typically a rectangle or square.

FIG. 13 is a schematic diagram of a typical AC wiring diagram for the system.

FIG. 14 is a graph showing a calibration and test curve for a preferred embodiment of the invention.

FIG. 15 is a set of three mass spectra over of they type used to generate the calibration curve of FIG. 14.

### DETAILED DESCRIPTION OF THE INVENTION AND BEST MODE

In a first broad embodiment there is disclosed the use a laser to vaporize any PBC or PCB like compounds in a painted surface sample, a sample cartridge to absorbed the vapors. The absorbent trap is delivered to a heated system to desorb the vapors and to split the vapors to a mobile GC/MS system and to a vented system device. Typical equipment needed: Laser; GC/MS unit; EZ Flash unit; a heated cartridge device; a vented system; Helium Tank (99.99% pure); generator; dry ice/liquid nitrogen; Van; material for casing of sampling arm. This system is sufficiently portable to take to client site and acquire samples for analysis on site.

A second broad embodiment of the invention includes an in situ PCB analyzer/monitor that uses a miniaturized, handheld YAG laser to acquire samples from solid surfaces. Typically the system acquires samples as the YAG laser fires at the solid surface and vaporizes, dissociating the materials present to base materials (in the case of a ship, the hull), and produces a sample circumference of approximately 5 mm unfocused and about 0.3 mm focused in approximately 10 nanoseconds, with about 10 Joules of energy and a temperature between 3000 and 5000 degrees Kelvin. It is believed that this sample size will be sufficient for confirming the presence or absence of PCBs on solid surfaces. In addition, this system may be modified to identify materials, such as lead, chromate, or others, with properties that can be identified by using GC, MS, ICP, TAGA, ICP/MS, or FT-IR.

Typically when vaporized, the materials of concern are quickly drawn by a miniaturized diaphram pump into a sample chamber (nominal size equivalent to that of a paintball chamber) that uses helium, nitrogen, or air as the inert carrier gas. This absorbent trap is then detached from the laser configuration and analyzed using a miniaturized, fast, field-portable GC/MS system (TDX EZ Flash™). This system analyzes for the constituent of concern (in this case, PCBs) and provides a printout or electronic results in approximately 10 minutes. The dissociation during sampling will provide the basis for identifying PCBs due to their unique nature.

Typically at the same time that the sample is acquired, a unique identification is given to each chamber sample and an auto engraving system identifies the wall surface with the sample number, which is also logged in on a read-only CD-ROM. Thus, there is no confusion regarding the identification of the sample. Additionally, it is planned that, at the same time the engraving is performed, the virtual coordinates of the sample will be identified on the test surface. This identification will be used to model the extent and location of the contamination and provide a virtual map to the sample locations.

Typically waste produced from this process is believed to be minimal due to the small volume required for a sample and the PCB collected is destroyed in the GC/MS. There is no extraction solvent waste generated, thereby reducing the volume of waste produced as part of the analytical process currently in use. It is projected that, by using this system to analyze for PCBs, the identification and reporting processes can be reduced from days/weeks/months to hours/days. This will provide clients cost savings by reducing wait time and management of areas not requiring decontamination.

Typical safety features of this system include two-stage interlock systems that make it difficult to inadvertently fire the system when not in proper position. Also, the second stage provides a red interlock light as a visual prompt to the technician that the system is ready to fire. Additionally, the system will not fire if the sample cartridge is not in position. This will help ensure that “valid” samples are acquired.

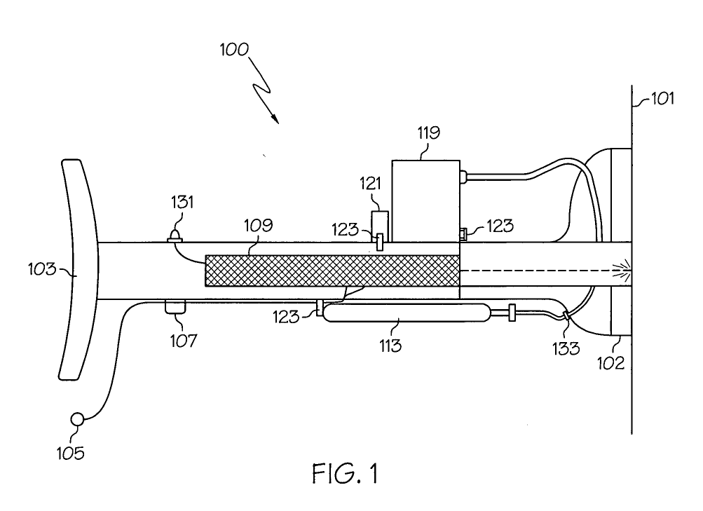

It is anticipated that one embodiment of a typical field-ready unit will be human platform operated (see FIG. 1), meaning that the system is sufficiently compact for a human to carry to whatever location is needed without extensive support systems. The only field requirement will be a constant uninterrupted power source. Gases such as nitrogen, helium or dry air that are needed to acquire samples can be contained in small unit-mounted pressure chambers (nominal size of 6 inches long and 2-3 inches in diameter).

Referring again to FIG. 1, the sampling system 100 according to this embodiment is placed on the surface to be sampled such as the hull of a ship 101 and held in place by pressure from shoulder pad 103. Ring pad 103 open in the center seals the sample area during the test. Power is provided through power connector 105. The sample is activated by trigger 107. On activation laser 109 is turned on and sends a beam 111 onto the test surface 101. As analyte is vaporized from heating and/or breakdown of the surface, gas from gas supply 113 enters the sample area through opening 115 and sweeps the analyte into opening 117 to the absorbent trap 119. A vacuum pump 121 typically aids in conducting the analyte carrying gas to the adsorbent trap 119. A quick release mechanism 123 for the adsorbent trap aids in speeding up the process. For safety, activation of the laser is indicated to the user by an indicator such as laser activation light 131. A quick disconnect may also be provided for the gas supply but is not as critical.

In other embodiments, it is important to note the concept of collection rests on the principle that the flow of sample material should be directed to a absorbent trap before the sample material has a chance to recombine and plate out on the walls. The stream is now sent straight to the collection filter placed only a short distance (2 cm) from the chamber into which the laser ablates the surface paint. To avoid deposits on the walls of the collection device the body of the device is heated.(T=200° C. to 250° C.). Typically, the wall of the chamber is massive enough to provide heat energy that keeps much of the volatile ablated material in the vapor phase until it has been captured at the filter. Typically, the chamber is shaped so that make up nitrogen or other inert gas will flow from the outside rim to the inside chamber, being heated as it moves. Typically, the outside rim has been made cool enough by the embodiment of the design so that the viton gasket can contact the wall without scorching or burning the sample surface (e.g. paint). Typically, laser energy is provided for sample vaporization through a line intersecting with the plane of a viton gasket placed on the surface. This laser beam is provided with optics that can be adjusted to change the size of the ablated area (spot).

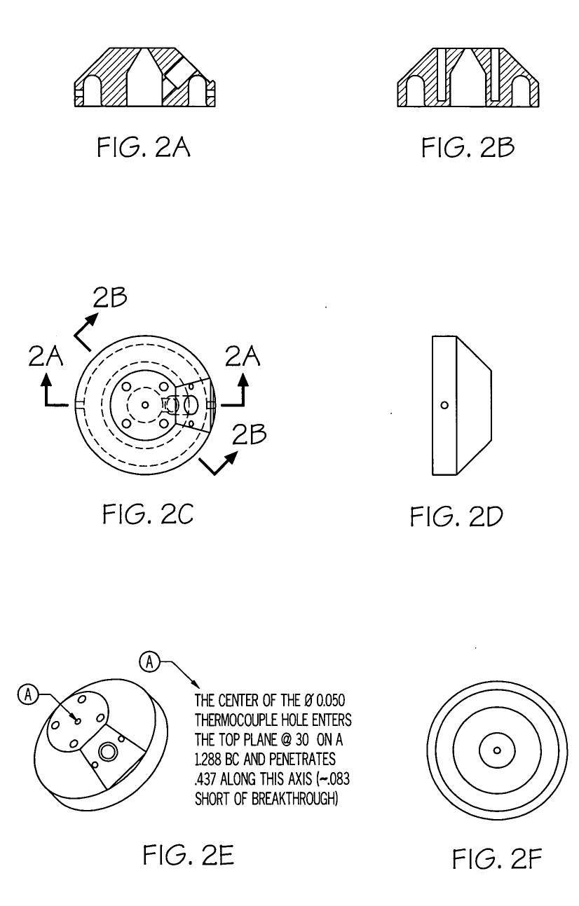

Referring now to FIG. 2, this figure depicts the typical configuration of the device at the time of the first tests. The main body of the device is typically aluminum or stainless steel. A Carbo trap tube was placed directly at the end of the hot cavity above the laser intersection with the center line of the device. The flow through the absorbent trap was powered by a diaphragm pump, which can be of fixed or variable speed. The filter materials have been chosen to preferentially capture PCB. Heating lines to keep the collector near 300° C. are used.

Tests of typical collection devices were made and tested: It was determined that the laser power being used in the early experimental tests was much higher than needed. Biphenylene, a combustion product of polychlorinated biphenyls has been observed with observations of spiked samples at 160 ng/cm². Later tests produced observations of PCB directly in the collected samples. The sample collector has been made to work. Further details of the products and sample collection and detection are discussed below.

As discussed above, using a laser method for collecting vaporized analytes such as polychlorinated biphenyls (PCB) materials out of paint matrices is quite feasible. Typically an absorption trap preferentially collects the vaporized materials from the laser ablated sample.

The PCB materials were observed using gas chromatography/flame ion ignition detector (GC/FID) and gas chromatography/mass spectrometry (GC/MS) techniques. The analyst can easily see the mass spectrometry ion pattern produced by the PCBs due to the multiple chlorine mass losses at concentration well below 100 micrograms/100 cm². The patterns match the pattern of the calibration spectra of the Arochlor 1254 standard, a common mixture of PCBs. Quantitative work was limited to several levels of contamination produced corresponding relative levels of identified PCB. The full quantitative database can be constructed following the teachings herein. The need for separation of pollutants from a paint matrix is applicable to more than just PCB materials. There are at least nine other pollutants of interest on the international level.

There are many PCB contaminated surfaces on military equipment (planes, ships, submarines and transport vehicles) and buildings due to the fact that the PCBs have been used as a fire retardant and/or a plasticizer in the paint on this equipment. When taking the equipment out of service, in scrapping equipment, the presence of PCB must be known so that proper disposition of the materials can be made under EPA regulations. At present the Navy and MARAD has hundreds of ships scheduled for disposal. About 98% of the Navy ships contain PCB. The Navy is required to check all painted surfaces for PCB before any cutting is undertaken. In addition, EPA requires that every load of scrap steel that leaves a shipyard be certified PCB free.

Using present verification procedures, samples must be scraped from the painted surface, sent to a laboratory, where the chemical extraction techniques are performed to separate the PCB s from the polymeric constituents of the paints. This separation makes it possible to use the standard GC and GC/MS procedures for the analysis. This laboratory analysis process is very slow (days-weeks) and requires delays in the fieldwork. These delays due to transportation time, sample handling time, analysis time and reporting time required for this process, add significant cost to the separations.

With the system disclosed herein, the sample will be analyzed in the field. Collection of the sample is performed by use of laser energy rather than physically scraping off the materials and performing solvent extraction. A laser takes off the sample in such a way that the sample can be directly analyzed in the field using gas chromatographic and mass spectrometric techniques, and produces little to no hazardous waste.

The development of a near-real time PCB analysis system for painted surfaces is disclosed herein. According to the teachings herein, a near real time PCB analysis system using a novel laser sample collecting device will allow samples to be directly collected and analyzed in the field.

The envisioned method is to collect polychlorinated biphenyls (PCB s) by separation from other paint constituents using a laser ablation of the material. The technical goal is to use an energy density that does not destroy the PCB molecules and yet separates them from the polymeric constituents of paint. When the laser fires at the surface, the energy density causes the surface of the paint to be torn into pieces, which fly up into the collector's cavity. Some of the pieces are larger than molecules but at least some of the PCBs (at the right conditions) are broken into molecular sizes or at least become available for direct separation from the paint. GC/ECD and or GC/MS techniques can identify the separated molecular PCB constituents, or other definite markers for PCBS.

Once the PCBs have initially been separated, it is necessary that they be captured in a collection media without plating out on the walls of the collector. This implies that the collection system in front of the media must be heated since the vapor pressure of the PCB materials is very low at room temperature (only 760 torr at about 400° C.) Since the amount of material is a very low percentage of the paint, the temperature could be set near 200-300° C. and full vaporization would still be achieved.

The system collects material over a set of areas on the surface, collecting for a specific number of pulses of the laser. In the first tests, the collector was mounted while the sample was moved under the intersection of the collector's laser beam. For example, for one sample collection, the laser was made to operate for 10 pulses (10 shots) on five different spots. (Early sample tests were used to indicate the extent of the sample collection needed for analysis). The sample tube was then disconnected from the collector and was analyzed by a GC-MS instrument.

Fieldable GC-Mass spec instruments are available for in-field analysis. Once the PCBs in molecular form have been separated from the paint, the tube can be carried a few meters (or many kilometers) after collection for the analysis. It is expected that the preferred method will be to make the measurement on-site for speed and convenience. After the collection, however, because the tubes contain solid room temperature PCB samples, it is not expected that there will be problems of sample degradation even in transit to an off-site analyzer.

Each set of tests is made of 8-10 sample tubes collected, followed by the analyses. More than 50 total samples were analyzed.

It is noted that in some cases spiked samples were made rather than using real analyzed samples obtained from ships. Several samples were made up with painted surfaces spiked with PCB Arochlor 1254.

TABLE 1
Benchmarks (Internal Deliverables)

| No. | BENCHMARKS | PERFORMED |
|---|---|---|
| 1 | (Spiking Paint Samples in the | Sample 1 (100 micro grams/ |
| | Laboratory | 100 cm²⁻) |
| | | Sample 2 (2 mgm/100 cm²) |
| 2 | Run Test Samples (Test runs 1-3) | Yes |
| 3 | Review Preliminary Data from | Yes |
| | Test Run 1-3 | |
| 4 | Run Examples 4-7 | Yes |

There were two parts to the experimental set-up used in the Part 1 tests, the PCB sample collection and the PCB analysis equipment. The Part 1 goal was to prove the principle of the laser driven sample collection method and its interface to the GC-MS. The GC-MS analysis method needed to be modified only at its interface with the absorbent trap to allow the standard GC-MS analysis to be made on the PCBS. The tubes are thermally desorbed to recover the samples. This sample is deposited at the entrance to the GC column. Therefore the analysis system used for the sample was not developed beyond this interface. This allows the use of standard GC-MS equipment as described in the analysis section below and interfaces with the EPA standard method for measurement (<50 ppm present by weight in a GC measuremen).

Description of Samples

Sample 1 was made up with two surfaces. On one surface, paint with 100 ug/100 cm² PCB was applied. On the other surface only the non-PCB containing paint was applied. There were also several layers of paint below the first layer that were verified as being below the EPA Standard (less than 10 ug/100 cm² PCB contaminated). Care was taken to collect samples from only the top layer by limiting the depth of sampling, controlling the number of laser shots on the sampling spots.

Sample 2 was made with surfaces of 1 mg/100 cm² and 2 mg/100 cm² and a third patch with only non-PCB containing paint. At first only a layer of 1 mg was painted on and analyzed in Example 5, but because variations were seen in collected material, an additional layer was analyzed in Examples 6 and 7.

Capture of the ablated material from the surface required the design and fabrication of a specialized surface collector. The purpose of the collector is to capture all material ablated from the surface and transport it to the sorbent tube with minimum loss. Although not included explicitly as a benchmark in the original plan, the collector was determined to be a key element of the collection system. FIGS. 2A-F shows one embodiment of a frame for PCB collection. The body or frame of the collector is the heart of the invention and is shown in the figures. The body is heated by four heated elements powered by a Variac set at about 50V (Setting 75). This device has several features which allow it to function as planned. The body of the device is heated to 250-300° C. under operation. This heated section proved temperature stable under operation attached. The sample is pulled through the cavity and through absorbent trap which functions as a molecular trap. In order to keep oxidizing combustion from the ablated sample, a stream of nitrogen was passed under the SS inner rim of the device to make up for the sample volume pumped through the tube. The flow was automatically adjusted to make up the sample flow assuring none of the sample was lost. This nitrogen flow was later found to be unnecessary for PCB analysis but is useful in analytes that oxidize.

FIGS. 2A through 2F show several faces of one embodiment of the frame for the sample collector. The optical interface of the laser with the collection system consists of a quartz window at about 45-degree angle from the surface. The laser is directed at the surface and intersects it in the center of the collector.

The Laser enters from the back side through a window on the bottom and intersects with the surface in the center of the cavity. The sample is drawn to the dark area in the upper part of the cavity. Makeup nitrogen flows under the wide rim where it is heated by the surface as it flows by.

The Laser used for ablation was a Contiuum Model Surelite I Nd:Yag laser operating at 1.064 micrometers wavelength. Its energy was varied by adjusting the Q switch delay between 4 mJ per pulse and 425 mJ per pulse. Its normal operation was at 10 pulses per second (10 Hz) but in order to test whether the sample needed to be cleared of the optical path in order to efficiently operate, it was also operated by manual trigger and at 0.5 Hz during some of the tests. This parameter did not product obvious changes in the results obtained. The laser size used is much larger than the laser expected to be used on the final system. In fact it is expected that a solid state laser of hand held size will be able to reach the energy density required. An alternative to a smaller laser is to couple this size laser to the collector by means of a fiber optic bundle. The latest embodiment has an energy of 40 ml/pulse and is fiber optically coupled.

Analysis for PCBs

After the sample is collected, which takes from about 1-3 minutes for a tube, the sorbent tubes collecting the sample were disconnected, capped, and hand carried to the Atmospheric Sciences and Applied Technology Mass spectroscopy facility for analysis. The tubes used to analyze the paint materials were originally about 7 inch by 0.25 inch stainless steel tubes made by Supelco and shortened to about 4.5 inches. Carbotrap 200 (70/80 glass beads, 20/40 Carbotrap B, 68/80 Carbosieve SIII) was packed into the tubes as a collection medium. Originally cleaned for 6 Hrs under nitrogen flow at 325° C., they could later be recleaned by the same technique performed for 2 hrs. The set was reused for each test.

During analysis, the sample tubes were individually placed in a small oven and thermally desorbed onto the GC trap at 275° C.-300° C. for 10 minutes with a nitrogen flow rate of about 35 cc/min. Several of the experiments were performed with this GC trap at room temperature because most if not all of the PCB constituents are trapped in this 10°-20° C. temperature because of their low vapor pressure. Other experiments were performed with this trap held at −100 C. Both worked but the room temperature trap holds only the low vapor pressure components effectively reducing the presence of high vapor pressure compounds.

The GC trap is then heated to 300° C. to transfer sample to the head of the column which is held at −50° C. for 2 minutes. The temperature of the column is programmed to rise at 8° C./minute (or 15° C./minute) to 280° C. and held for (18 minutes)-28 minutes. It took the PCBs about 40-50 minutes to move through the column at the 8° C./minute rate of heating.

The instrument used for earlier analysis was the HP 5880 GC with FID and 5970 MSD with Chemstation software. This is not a state of the art system implying that there is room for engineering and cost considerations to be made when specifying the field system. The best technical system need not be chosen for successful operation. Any commercially available system that can be used for EP8082 type work is sufficient.

The test matrices by sample are summarized in Table 4. In Table 4 sample measurements are labeled with test numbers and a letter designation (e.g., Example 7A.) At first, the amount of sample needed for the analysis was unknown, so in the first Examples there was an effort to vary collection parameters to ensure observation of enough material. Examples 3, 4 and 5 and 6 were run with a cold trap. With the cold trap operating, because of the large amount of material traveling through the system, some of the mass spec runs were not successfully completed because they saturated the mass spectral instrumentation. (No mass spectrometry analysis for these runs was obtained). After Example 6 several calibration runs were made which proved that room temperature trapping at the GC trap at near room temperature also worked well for capturing PCBs and that the cold trap might be a more complicated procedure than required.

### EXAMPLE 1 TO EXAMPLE 3

### Initial Series of Examples

The laser power for Example 1 was 425 mJ per pulse focused on a spot of about 2 mm diameter (Energy density about 10,000 mJ/cm²). Observation of Sample 1 was made. In this example series biphenylene in four times greater amounts in the PCB contaminated samples than in the non-PCB contaminated samples was observed. Biphenylene is a structural relative to the biphenyl which is a structural relative of PCB. In this example a ramp time of 15° C./minute for the GC was used. Besides the biphenylene, it was to be able to see PCB materials at ˜26 minutes retention time. When analysis in this period was done on the small peaks, the mass spectrometry instrument made no PCB identification. Nor did there seem to be a GC pattern in the region that was recognized as the PCB. It was concluded that there was a possibility that the PCB materials were being destroyed. Consequently, the laser power was lowered on the next set of examples. Note that depending on the surfaces tested, a range of laser energy densities of about 1,000 mJ/cm² to about 100,000 mJ/cm² are possible with this laser device.

For Example 2, the laser power was 150 mJ per pulse (3000 mJ/cm² per pulse) again focused on a spot of about ˜2 mm on Sample 1. In these examples again biphenylene in four times greater amounts were observed in the PCB contaminated samples than in the non-PCB contaminated sample. Still no PCBs were observed.

In the Example 3 test, laser pulses of 4 mJ using the same lens position were used at the start, but this energy density was not enough to ablate the paint on Sample 1. This energy yielded no spot at all. The energy for Example 3 was then raised to 19 mJ and 46 mJ per pulse. Variations in the number of shots were made to compensate for the change in energy in order to obtain a constant amount of material for the analyses. In the analysis there seemed to be more material, (but a cold trap is also being used to collect it at the GC in the belief that PCB material may be being lost). The analysis in this example yielded the identification of biphenyl as well as biphenylene. The quantification of these runs showed a tendency to have higher biphenylene and biphenyl in the observations of the PCB materials but the results did not yield as clear a ratio as did the higher powered examples. Looking back with 20-20 vision, these runs were still too short to observe PCBs which were later found to have had a longer retention time.

In Example 2 and Example 3 tests a ramp time of 8° C./minute was inadvertently used instead of the intended setting of 15° C./min for the GC. This occurred because the system was automatically reset when the system failed at one point overnight. PCB materials were expected to be seen, however, no materials past the biphenylene peaks were found. There was a possibility that the PCB materials were being destroyed, but later it was found that the inadvertent shift in the time by the automatic reset had pushed the PCBs out of the range and in fact out to past 40 minutes. It is possible that at these energy densities were not destroying the PCBs. This question, however, has not been pursued since the PCBs were observed at a lower power density that is more advantageous anyway.

At the end of the initial runs PCBs were not identified directly, but it was felt that there was strong evidence that the presence of the PCB could be obtained by monitoring the biphenyl concentration. This evidence looked weaker as the energy of the laser was reduced. The presence of biphenylene as a substitute for PCB was also not totally unambiguous because the measurements indicated that even in non-PCB containing paint there is some biphenylene and biphenyl present or produced by the process.

### EXAMPLE 4, 5 AND 6

Sample 1 was again observed in Example 4 and was basically a repeat of Example 3. The energy was kept at 19 mJ per pulse in Example 4 in order to try to find the PCB materials directly. The analysis again yielded the identification of biphenyl as well as biphenylene. The quantification of this did not yield as clear a ratio of the two products between the PCB and Non-PCB material as the higher-powered tests had shown. Looking back again with 20-20 vision these runs were 40 minutes in maximum retention time, still too short to observe PCBs and more material needed to be collected to see Sample 1 under the conditions the GC was set at.

It was decided to spike a sample at high levels to aid in finding the PCB peaks. For Example 5, Sample 2 with PCB spiked at 1 mg/100 cm² was observed. For Example 5 the energy was also raised to 49 mJ/pulse. The paint layer was too thin and the sampler was going completely through the layer of paint. This layer was not very even. The quantification of this did not yield as clear a ratio of the products biphenyl and biphenylene as the higher powered tests with the thicker layers. This phenomenon was attributed to the uneven layers of paint. Some of these runs were 50 minutes long rather than 40 minutes. Having noted that the runs might be too short, after the first few tubes, the maximum retention time of 40 minutes was extended to 50 minutes. At first, the small differences in the peaks in this later time region was not noted, but on reanalysis direct evidence of PCBs was found in the long runs of Example 5 directly in the CG-MS Spectrum Several other points of worry were investigated in Example 5. First, it was verified that the cleaned tubes were actually clean. An unopened tube run as if it had been used for collection produced an almost perfectly clean GC scan. Second, a test on a tube that was opened and exposed to flow without use of the laser produced a surprising amount of material when the collector was placed over the top of the PCB surface. At this point the question of air cleanliness was raised. This later was dispelled when it was found that there was very little response from a tube that had been collecting for two minutes away from the surface in Example 6.

### EXAMPLE 6

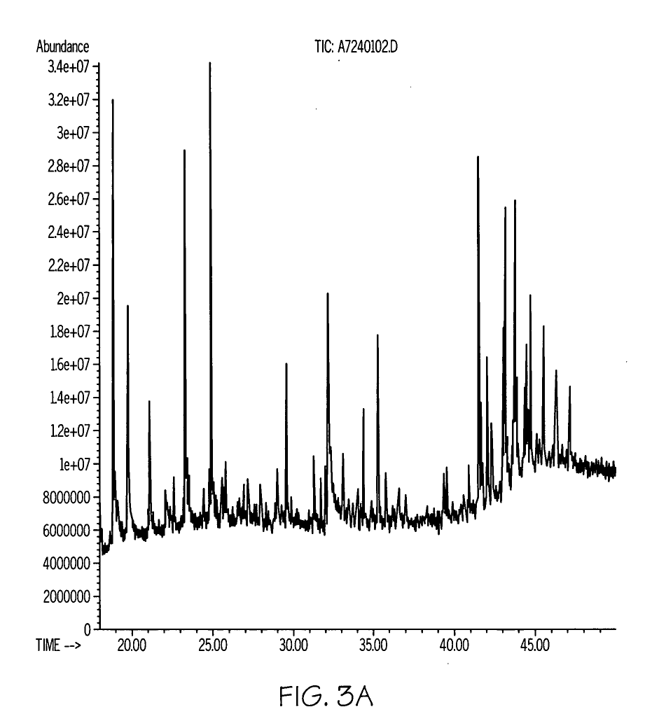

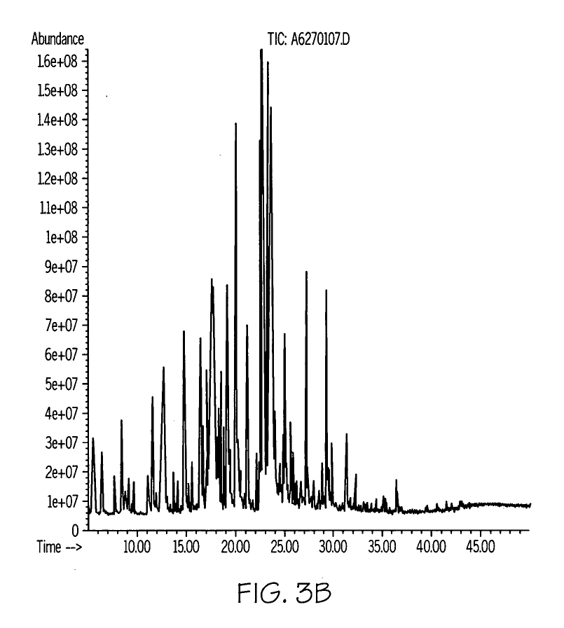

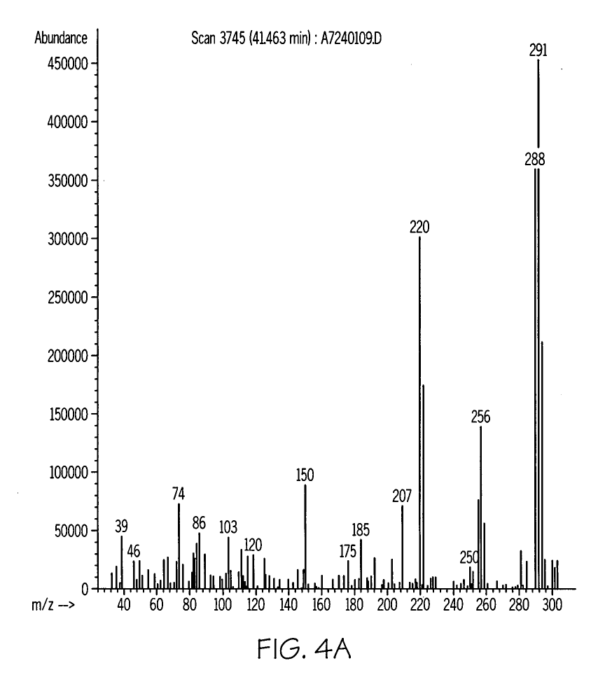

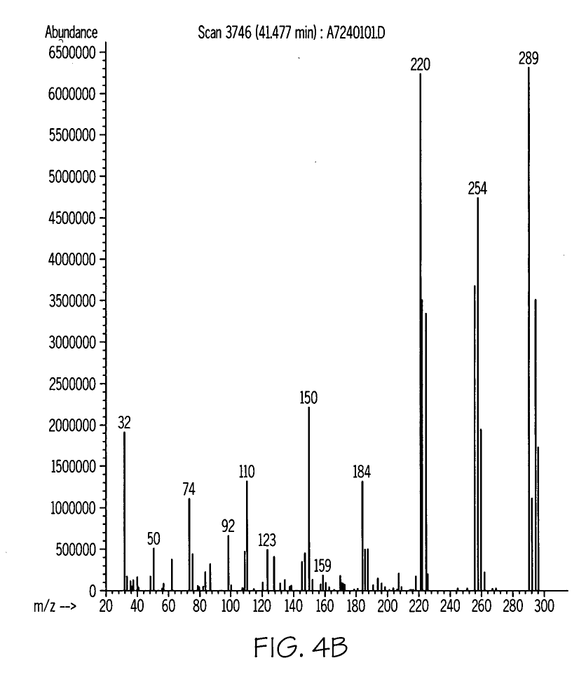

For Example 6 more spiked paint was added on the PCB layer of Sample 2 and also more clean paint was added on the non-PCB layer. The PCB level on Sample 2 was 2 mg/100 cm². All examples were collected using 49 ml per pulse 10 shots on 10 spots. For the first time it was noticed that there were small eluting components at times between 40 and 50 minutes retention time in the PCB runs that were not in the non-PCB exposed samples. These are seen in the right scan of FIGS. 3A and 3B past 40 minutes. Mass spectrometry identification yields a pattern that is observable 154 biphenyl, 185 chlorobiphenyl, 220 bi-chlorobiphenyl and 254 tri-chlorobiphenyl, and 290-292 quadra-biphenyl isomers. FIGS. 4A and 4B show this pattern in a calibration spectrum of PCB being detected at one retention time. This pattern is compared in the same figure to the pattern at the same retention time of the Arochlor 1254 calibration run. They match. In Example 6 quantification using the mass spectrometry abundances was shown also by an analysis using a normalization of the amount of material in peaks 28 minutes to 39 minutes and rationing the PCBs seen from 40 minutes to 47 minutes to them. PCBs are present after 40 minutes and in fact are consistent with the calibration run performed after this run. Three distinct levels were observed, after subtracting out the background levels. This shows the possibility of the quantified operation.

Since PCBs are observed only in the later retention times and nothing was analyzed earlier, it was decided that too much material was being collected in the early part of the run. In FIGS. 3A and 3B, the observation of PCB from Examples 6 in which the cold trap was used and Example 7 in which the room temperature trap was used to collect the PCB materials, letting lighter higher vapor pressure components be driven from the trap before the start of the GC run. This led to the conclusion that a cold trap was not necessary.

Referring now to FIGS. 3A and 3B, FIGS. 3A (left) and 3B (right) shows the difference in the GC Runs when using a cold trap as in Example 6 at right and the relative cleanliness of the warm trap collection of the PCBs at left. PCB are the main constituents not lost or at least partially recovered with the warm trap Note chromatogram at right is 10× the scale of the left. The spectrum at left is the ion abundance scan of Arochlor 1254 calibration of Example 7 at a retention time of 41.5 minutes. The right spectrum shows the observation of 5 cm²) 100 micro gms/100 cm² (Sample 1) at the same retention time. Both spectra show the ion spacing pattern of successive lost chlorine atoms from multichlorinated isomers of PCB.

### EXAMPLE 7

Whether collection was affected by retention time and multiple pulses of the laser on the ablated material in transit was tested. Several runs were made with and without the PCBs on Sample 2. Some of the runs were made at 10 Hz (pps) and some of the runs were made at 0.5 Hz with all the other conditions being the same. The number of pulses per second appeared to make no difference at all in the amount of material collected or PCB observed.

The next question had to do with the level that could be observed. Sample 1 observations were also made and compared to Sample 2 measurements.

Results of Comparison of Sample 2 PCB at 2 mg/100 cm² with Background Sample 2 Observations

Keeping the same energy density, it was decided to increase the spot size so that the material could be collected faster. This was particularly necessary in the subsequent measurements on Sample 1 in which the concentration was nearer the lower detection limit of the technique. Using the energy density that was found to work in the previous experiments, observations were made on Sample 2. Sample 2 is the 2 mg/100 cm² spiked Sample 5. The spot size for Example 7 was approximately 5 times the spot size of the previous examples. Area was about 0.2 cm² per spot. Spots covering a total area of about 1 cm² were observed for each sample tube collected, on both the PCB contaminated area and

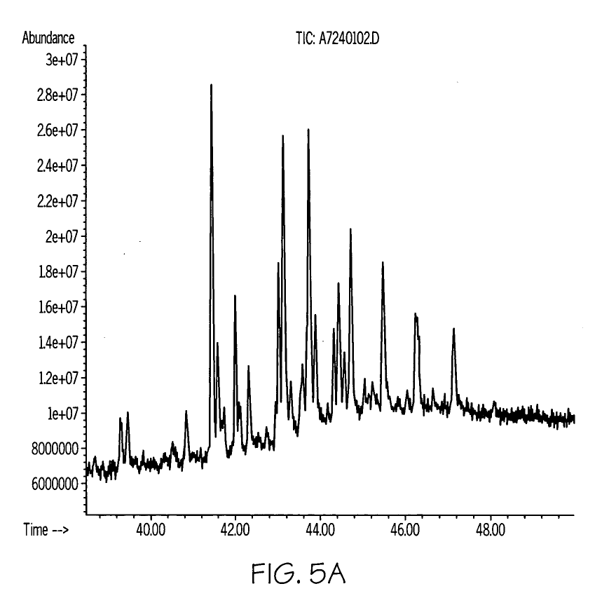

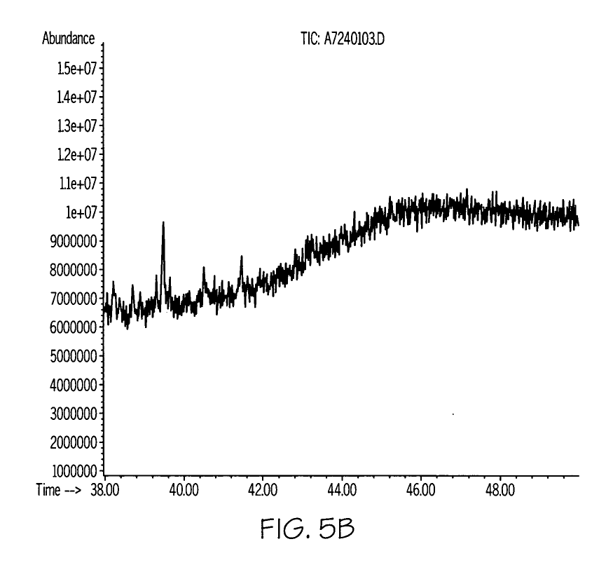

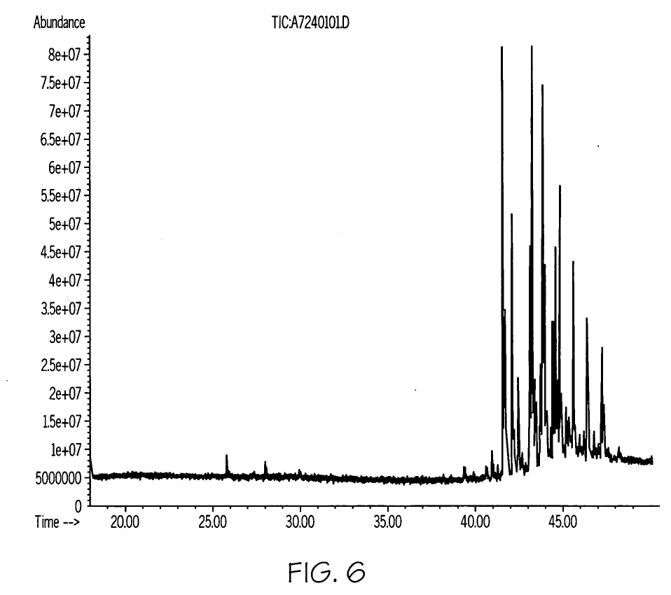

FIGS. 5A and 5B show two chromatographs of Example 7 observing the Sample 2 PCB (2 mg/100 cm²) observation with a test on a sample from the Sample 2 non-PCB surface. Background levels indicate that this pattern could be seen below 0.5 mg/100 cm² the Non-PCB contaminated area. The scans in FIGS. 5A and 5B show comparison scans of PCB (left) versus non-PCB (right). The pattern of the lines in FIG. 5A at left are equivalent in shape to the pattern seen in the calibration run of Arochlor 1254 shown in FIG. 6. FIG. 6 shows the Abundance level versus the Retention time observed for a 5 micro-gram sample of PCB Arochlor 1254 used as a calibration point. Features after 40 minutes are all PCB isomer elutions. FIG. 6 shows a chromatographic pattern of Arochlor 1254 which looks like an equivalent pattern to the sample of PCB observed in FIGS. 5A and 5B.

Table 2 shows the results of an analysis of the total ions at retention times corresponding to the time period the PCB isomers are eluted from the GC. At this high concentration there are no interfering peaks. Observation of the peaks at a sampling of retention times indicates that the PCB peaks can be distinguished from the interferences. The pattern of ions near 292, 256, 220, 185 and 154 were observed in the contaminated peaks and found to be absent in the background sample. Abundances of this ion pattern compounds in the background are absent. There are only very small features in the background runs observed.

TABLE 2
Total Ion Observations of Sample 2 at Retention times in the
Calibration Period

| | Calibration Run | No PCB | Mass Spec | | Mass Spec |
|---|---|---|---|---|---|
| Retention | Relative Peak | Relative Peak | Pattern | PCB 2100 ug/100 cm² | Pattern |
| Times | Height | Height | Confirmation | Relative Peak Height | Confirmation |
| Minutes | Total Ion | Total Ion | Indicates | Total Ion | Indicates |
| 41.48 | 8 | | | 1. | Yes |
| 41.62 | 3 | 0.7 | No | | |
| 42.02 | 5 | 0.3 | No | 0.05 | Yes |
| 42.73 | | | | 0.2 | No |
| 42.81 | | | | 0.8 | No |
| 43.02 | 4.5 | | | 0.05 | Yes |
| 43.16 | 8 | | No | 0.05 | Yes |
| 43.69 | | 0.7 | | | |
| 43.76 | 7.5 | 0.1 | No | 1.0 | Not All |
| 44.46 | 4.5 | 0.01 | | | |
| 44.75 | 6 | | | 0.03 | Yes |
| 45.51 | 4 | 0.03 | No | | |
| 46.30 | 3.5 | | | | |

Results of Comparison of Sample 1 PCB at 100 ug/100 cm² with Background
Sample 1 Observations

Using the energy density (1000 mJ/cm²) that was found to work in the previous experiments, observations were made on Sample 1. Twenty-five Spots covering a total area of 5 cm² were observed, on both the PCB contaminated area and the Non-PCB contaminated area. The large number of spots were observed because it is necessary to collect more material to ensure an acceptable signal to noise at this low concentration. This is an indication of the amount of area on which the measurement needs to be made for a successful field measurement with this GC-MS device. Later experiments with newer equipment allowed smaller sample sizes.

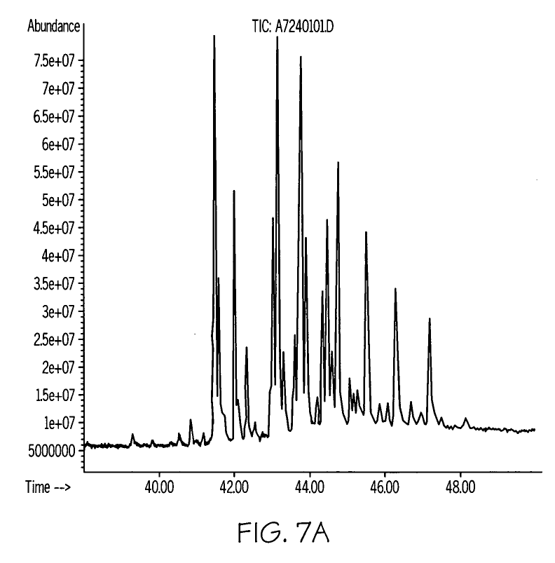

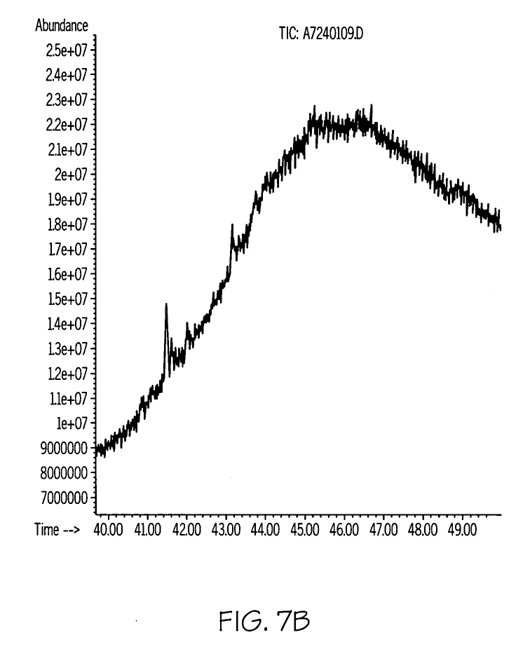

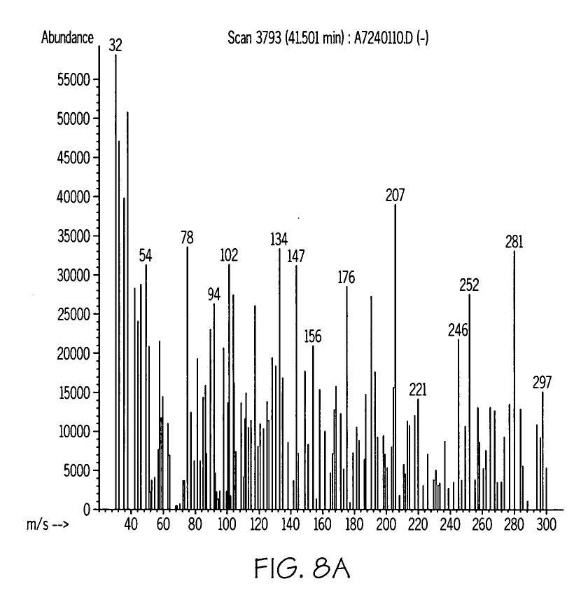

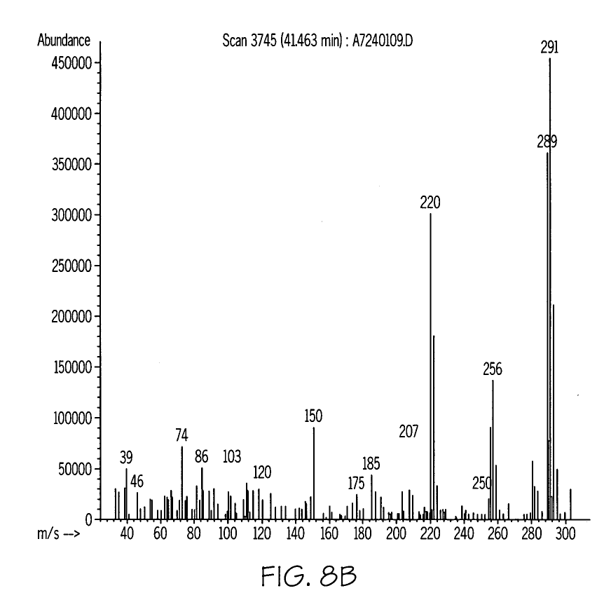

FIGS. 7A (left) and 7B (right) show the calibration pattern (left) as compared to the Observed pattern on Sample 1(right). FIGS. 8A (left) and 8B (right) show an example of the results of an analysis of the total ions at retention times corresponding to the time period the PCB isomers are eluted from the GC. At this low concentration there are interfering background and some additional peaks in the region. Observation of the peaks at PCB retention times indicates that the PCB peaks can be distinguished from the interferences. The pattern of ions near 290, 254, 220, 185 and 154 were observed in the sample contaminated with PCB and found to be absent in the background sample as shown at right.

FIGS. 7A (left) and 7B (right) show the PCB eluting region of the calibration run (5 micrograms Arochlor 1254). At right is the PCB region of the (Sample 1) chromatogram showing PCB peaks. Note that the strong continuous background, likely due to varying length chains of hydrocarbons is easily subtracted off.

FIGS. 8A (left) and 8B (right) show a comparison of mass spectrometry results at retention time 41.5 minutes. On the left is shown the Sample 1 PCB observation. On the right is the non-PCB paint background. Note that the pattern for PCB observation is present at left.

Table 3 gives a summary of the mass spec confirmation and non-confirmation of the PCB pattern for each peak observed. There is more ambiguity in this set but the PCB identification is still clear at the stronger peaks.

TABLE 3
Total Ion Observations of Sample 1 at Retention times in the
PCB Region

| | Calibration | | | | |
|---|---|---|---|---|---|
| | Run | No PCB | | PCB | |
| | Relative | Relative | Mass Spec | 100 ug/100 cm² | Mass Spec |
| Retention | Peak | Peak | Pattern | Relative Peak | Pattern |
| Times | Height | Height | Confirmation | Height | Confirmation |
| Minutes | Total Ion | Total Ion | Indicates | Total Ion | Indicates |
| 41.48 | 8 | | | 1. | Yes |
| 41.62 | 3 | 0.7 | No | | |
| 42.02 | 5 | 0.3 | No | 0.05 | Yes |
| 42.73 | | | | 0.2 | No |
| 42.81 | | | | 0.8 | No |
| 43.02 | 4.5 | | | 0.05 | Yes |
| 43.16 | 8 | | No | 0.05 | Yes |
| 43.69 | | 0.7 | | | |
| 43.76 | 7.5 | 0.1 | No | 1.0 | Not All |
| 44.46 | 4.5 | 0.01 | | | |
| 44.75 | 6 | | | 0.03 | Yes |
| 45.51 | 4 | 0.03 | No | | |
| 46.30 | 3.5 | | | | |

Technical Conclusion and Recommendations

Using a laser method for collecting PCB materials out of paint matrices is quite feasible. It was observed that the PCB materials using GC/FID techniques at 2 mg/100 cm² level with high signal to noise. Based on results of measurements on Sample 2 it was estimated that the GC area might be sufficient for the identification with concentrations as low as 500 micrograms/100 cm². Data collected on Example 7 Sample 1 show that using GC/MS one can identify PCB materials in paint at levels below about 100 ug/100 cm², although some future work will have to be performed that will automate the pattern recognition. The analyst can easily see, at concentrations well below 100 micrograms/100 cm², the mass spectrometry ion pattern produced by the PCBs due to the multiple chlorine ion mass loss. These patterns match the calibration spectra for the Arochlor 1254 standard. It also has been demonstrated by Example 6 data that this collection can be performed quantitatively. Further, a collector was build that would operate well as a field system, and a absorbent trap that preferentially collects the PCB materials.

TABLE 4
Summary Table of Samples Observed.

| | Laser | | | Dia | T | | PCBs | Markers | | Mass | | GC or MS |
|---|---|---|---|---|---|---|---|---|---|---|---|---|
| | Power | Shots | Spots | mm | ° C. | Sample | Observed | Observed | Retention | Spec | Tube | Identification |
| Test | 472 mJ | Varied | 5 | V | 269 | Sample 1 | No | No | — | — | — | — |
| Set 1 | | (V) | | | | (100 micro- | | Analysis | | | | |
| | | | | | | gm/decimeter) | | | | | | |
| Test | 472 | 25 | 10 | 2 | | Sample1- | No | Material- | 40 | No | L006 | 5880AROC.15R |
| 1a | | | (2) | | | PCB) | | biphenylene | | PCB | | |
| Test | 472 | 25 | 10 | 2 | | Sample1-PCB | No | Material- | 40 | No | L004 | 5880AROC.16R |
| 1b | | | | | | | | biphenylene | | PCB | | |
| Test | 472 | 25 | 10 | 2 | 276 | Sample1-PCB | No | Material | 40 | No | L011 | 5880AROC17 |
| 1c | | | | | | | | and less | | PCB | | |
| | | | | | | | | biphenylene | | | | |
| Test | 472 | | | | | Sample1-PCB | No | Material- | 40 | | L001 | 5880AROC18R |
| 1D | | | | | | | | biphenylene | | | | |
| Test | 472 | | | | | Sample 1 | No | Material | 40 | | L011 | 5880AROC20R |
| 1E | | | | | | New Paint | | and less | | | | |
| | | | | | | No PCB | | biphenylene | | | | |
| | | | | | | Sample 1 | | | | | | |
| Test | 152 | 25 | 4 | 2 | 268 | Sample 1 | No | Materials | 40 | | L004 | 588AROC21 |
| 2a | | | | | | PCB | | and less | | | | |
| | | | | | | | | biphenylene | | | | |
| Test | 152 | 25 | 4 | 2 | 263 | Sample 1 No | No | biphenylene | 40 | | L006 | 588AROC22R |
| 2b | | | | | | PCB | | | | | | |
| Test | | | | | | Sample 1 | No | biphenylene | 40 | | L001 | 5880AROC.23R |
| 2c | | | | | | PCB | | | | | | |
| Test | 4 mj | 25 | | | | Sample 1 | No | No | 40 | | — | — |
| 3a | | | | | | PCB | | analysis | | | | |
| Test | 19 mj | 100 | 10 | | | Sample 1 | No | Biphenylene | 40 | | L001 | AC060701.04R- |
| 3b | | | | | | PCB | | (BPNLene) | | | | mass |
| | | | | | | | | and BiPhenyl(BPNL) | | | | spectrometry |
| Test | 19 | 100 | 10 | | | Sample 1 No | No | BPNLene | | | L004 | AC060701.03R |
| 3c | | | | | | PCB | | &BPNL | | | | |
| Test | 19 | 200 | 10 | | | Sample 1 | No | BPNLene | | | L006 | AC060701.05R |
| 3D | | | | | | PCB | | &BPNL | | | | |
| Test | 19 | 200 | 10 | | | Sample 1 No | No | BPNLene | | | L011 | AC060701.01R |
| 3E | | | | | | PCB | | &BPNL | | | | |
| Test | 19 | 200 | 10 | | | Sample 1 No | No | BPNLene | | | L008 | AC060701.02R |
| 3F | | | | | | PCB | | &BPNL | | | | |
| Test | 46 | 100 | 10 | | | Sample 1 No | No | BPNLene | | | L012 | AC060701.06R |
| 3G | | | | | | PCB | | &BPNL | | | | |
| Test | 46 | 100 | 10 | | | Sample 1 | No | BPNLene | | | L005 | AC060701.07R |
| 3H | | | | | | PCB | | &BPNL | | | | |
| Test | 19 mj | 25 | | | | Sample 1 | No | BPNLene | 40 | | L010 | AC061901.01R |
| 4a | | | | | | 100 ug/deciliter | | &BPNL | | | | |
| Test | 19 mj | 25 | | | | Sample 1 | No | BPNLene | 40 | | L002 | AC061901.02R |
| 4b | | | | | | PCB | | &BPNL | | | | |
| Test | 19 mJ | 100 | | | | Sample 1 | No | BPNLene | | | L007 | AC061901.03R |
| 4c | | | | | | No PCB | | &BPNL | | | | |
| Test | 19 mJ | 100 | | | | | No | BPNLene | | | L009 | AC061901.04R |
| 4D | | | | | | | | &BPNL | | | | |
| Test | 19 | 200 | | | | | No | BPNLene | | | L008 | AC061901.05R |
| 4E | | | | | | | | &BPNL | | | | |
| Test | 19 | 200 | | | | | No | BPNLene | | | L011 | AC061901.06R |
| 4F | | | | | | | | &BPNL | | | | |
| Test | 19 | 200 | | | | | No | BPNLene | | | L004 | AC061901.07R |
| 4G | | | | | | | | &BPNL | | | | |
| Test | 19 | 100 | | | | | No | BPNLene | | | L001 | AC061901.08R |
| 4H | | | | | | | | &BPNL | | | | |
| Test | 0 | — | — | 2759 | | Over the Top | | No PCB | | | L010 | AC062701.01R |
| 5A | | | | | | of Sample 1 | | | | | | |
| | | | | | | PCB | | | | | | |
| Test | 49 | 20 | 5 | 275 | | Sample 1 All- | | PCB | | | L001 | AC062701.02R |
| 5B | | | | | | PCB | | | | | | |
| Test | 49 | 20 | 5 | 272 | | Sample 1 All | | PCB | | | L012 | AC062701.08R |
| 5CE | | | | | | PCB | | | | | | |
| Test | 49 | 20 | 5 | 273 | | Sample 1 All | | No PCB | | | L004 | AC062701.03R |
| 5D | | | | | | Paint-NoPCB | | | | | | |
| Test | 49 | 20 | 5 | 272 | | Sample 1 All | | No PCB | | | L005 | AC062701.05R |
| 5E | | | | | | Paint-No PCB | | | | | | |
| Test | 49 | 20 | 5 | 273 | | Sample 1 | | PCB | | | L009 | AC062701.04R |
| 5F | | | | | | Paint3-PCB2 | | | | | | |
| Test | 49 | 20 | 5 | 272 | | Sample 1 All | | PCB | | | L007 | AC062701.06R |
| 5G | | | | | | Paint 2-PCB 3 | | | | | | |
| Test | 49 | 20 | 5 | 272 | | Sample 1 | | PCB | | | L011 | AC062701.07R |
| 5H | | | | | | Paint3-PCB2 | | | | | | |
| Test | 49 | | | | | Sample 1 | | PCB | | | L008 | AC062701.09R |
| 5I | | | | | | Paint2-PCB3 | | | | | | |
| Test | Blank | | | | | Tube Blank | | No PCB | | | L002 | AC062701.010R |
| 5J | | | | | | | | | | | | |
| Test | 49 | 10 | 10 | 274 | | Sample 2 | Yes | No PCB | 50 | | L007 | AC071601.01R |
| 6A | | (10/s) | | | | Paint- | | | | | | |
| Test | 490 | 10 | 10 | 269 | | Sample 2 | Yes | No | 50 | | L011 | AC071601.02R |
| 6B | | (10/s | | | | Paint | | PCB | | | | |
| Test | 49 | 10 | 10 | 270 | | Sample 2 | Yes | PCB | 50 | PCB | L009 | AC071601.03R |
| 6C | | (10/s) | | | | Half Paint- | | | | | | |
| | | | | | | PCB | | | | | | |
| Test | 49 | 10 | 10 | 266 | | Sample 2 | Yes | PCB | 50 | | L004 | AC071601.04R |
| 6D | | (10/s) | | | | Paint-PCB | | | | | | |
| Test | 49 | 10 | 10 | 267 | | Sample 2 | Yes | PCB | 50 | | L012 | AC071601.05R |
| 6E | | (10/s) | | | | Paint-PCB | | | | | | |
| Test | 49 | 10 | 10 | | | Sample 2 | Yes | PCB | 50 | | L008 | AC071601.06R |
| 6F | | (10/s) | | | | HalfPaint- | | | | | | |
| | | | | | | PCB | | | | | | |
| Test | — | 0 | | RT | | Room Air | No | No PCB | 50 | No | L005 | AC071601.07R |
| 6G | | | | | | | | | | PCB | | |
| Test | — | 0 | | 270 | | Over Sample 2 | No | No PCB | 50 | Material | L001 | AC071601.08R |
| 6H | | | | | | | | | | No | | |
| | | | | | | | | | | PCB | | |
| Test | — | 0 | | RT | | NOT | No | No PCB | 50 | No | L006 | AC071601.09R |
| 6I | | | | | | OPENED | | | | PCB | | |
| Test | — | | | 270 | | Over Sample 2 | No | No | 50 | Material | L010 | AC071601.010R |
| 6J | | | | | | Paint after | | PCB | | No | | |
| | | | | | | cleaning | | | | PCB | | |
| Test | 218 | 10 | 5 | 275 | | Sample 2 | No | No PCB | 50 | No | L009 | AC072401.10R |
| 7A | | (10/s) | | | | Paint | | | | PCB | | |
| Test | 218 | 10 | 5 | 263 | | Sample 2 | No | No PCB | 50 | No | L011 | AC072401.03R |
| 7B | | (10/s) | | | | Paint | | | | PCB | | |
| Test | 218 | 10(10/s) | 5 | 257 | | Sample 2 | Yes | PCB | 50 | PCB | L005 | AC072401.02 R |
| 7C | | | | | | Paint-PCB | | | | | | |
| Test | 218 | 10 | 5 | 254 | | Sample 2 | Yes | PCB | 50 | PCB | L004 | AC072401.09R |
| 7D | | (10/s) | | | | Paint-PCB | | | | | | |
| Test | 218 | 10 | 5 | 251 | | Sample 2 | Yes | PCB | 50 | PCB | L012 | AC072401.08R |
| 7E | | (0.5/s | | | | Paint-PCB | | | | | | |
| Test | 218 | 10 | 5 | 257 | | Sample 2 | Yes | PCB | 50 | PCB | L006 | AC072401.04R |
| 7F | | (0.5/s) | | | | Paint-PCB | | | | | | |
| Test | 218 | 10 | 5 | 255 | | Sample 2 | No | No PCB | 50 | No | L008 | AC072401.05R |
| 7G | | (0.5/s) | | | | Paint | | | | PCB | | |
| Test | 218 | 10 | 25 | 260 | | Sample 1 | Yes | PCB | 50 | PCB | L001 | AC072401.06R |
| 7H | | (0.5/s) | | | | (100 micro- | | | | | | |
| | | | | | | gm/decimeter) | | | | | | |
| Test | 218 | 10 | 25 | 275 | | Sample 1 | No | No PCB | 50 | No | L010 | AC072401.07R |
| 7I | | (0.5/s) | | | | (100 micro- | | | | PCB | | |
| | | | | | | gm/decimeter) | | | | | | |
| Test | Calib | 1 | 0 | — | — | 5 ug Arochlor | 5 ug | PCB | 50 | PCB | L007 | AC072401.01R |
| 7J | | | | | | 1254 | Aro | Standard | | | | |
| | | | | | | | chlor | | | | | |
| | | | | | | | 1254 | | | | | |

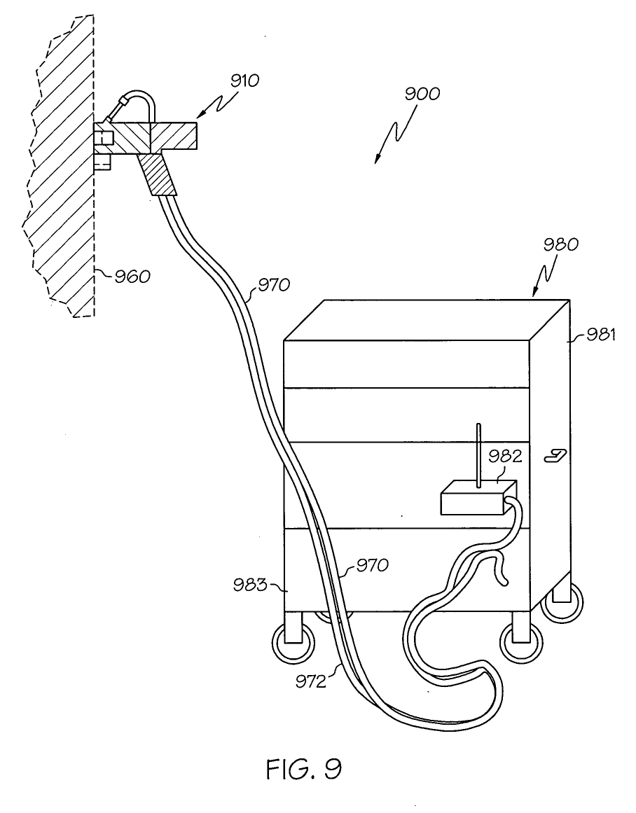

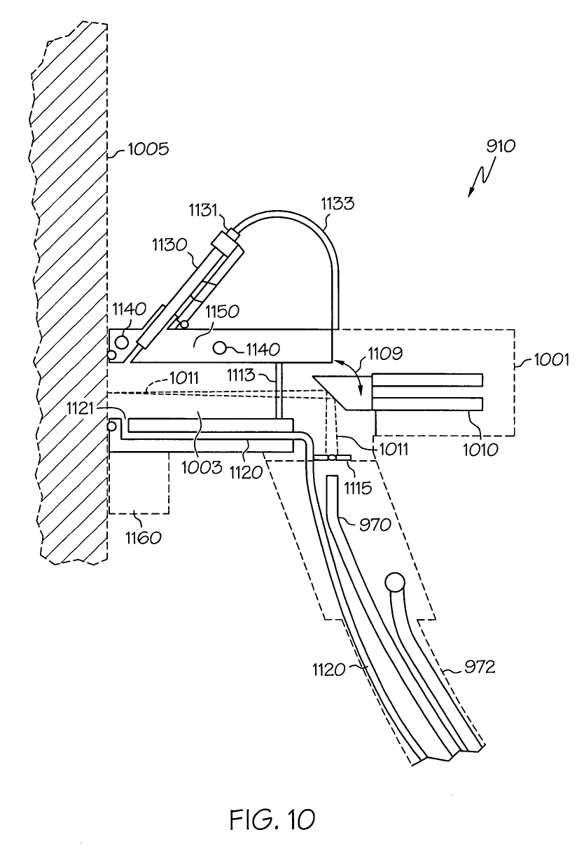

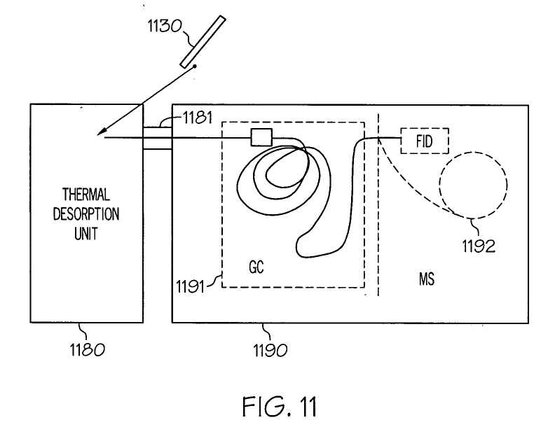

Referring now to FIG. 9, a further embodiment of the invention is an analyte (e.g. PCB) analytical system. Typically a full version of the analytical system consists of a sample module 900 (sampling head 910, see FIGS. 9 and 10, and control assembly, see FIG. 9) and the analytical assembly module, see FIG. 11. The sampling head 910 is typically hand held or surface mounted and used to collect the surface samples from various surfaces 960. The control module 980 is typically mounted on a cart 981 or carried into the sample area by hand (e.g. suitcase size modules) or by trailer and provides various devices such as pumps, logic modules, temperature controllers and temperature monitors. Mounted in the cart is typically a laser unit 982 that provides a laser beam for the sampling head via an optic cable 970. The laser is typically a Nd:Yag laser operating at 1064 nm, providing energy at up to 5 pulses per second at an energy of about 40 ml per pulse. Other cables 972 may be used for communication or power supply between the sample head 910 and the control module 980. The bottom unit in the cart is typically a controller 983 such as a Sierra Instrument Newport ESP-300 Controller.

Referring now to FIG. 10, there is shown a detailed view of the sampling head 910. Typically the unit comprises a frame 1001 for holding and the various parts and for forming an enclosed volume 1003 where the sampling takes place. The sample head 910 it typically placed against a surface 1005 so that the open end 1007 of enclosed volume 1003 touches the surface 1005. A mirror control assembly 1010 provides control of a laser beam 1011 that provides the energy for vaporizing a sample analyte. Typically a transparent window 1113 (CVI W2-PW-1025-C-1064-0) is used to shield the mirror control assembly from any contaminants generated by the laser at the surface. Laser beam focusing lens 1115 may or may not be needed. When a sample is ready to be collected by generation of vaporized analyte the surface a flow of gas from gas line 1120 at opening 1121 sweeps the analyte into a second opening 1123 leading to adsorbent trap 1130. Adsorbent trap 1130 is typically held in place by disconnects 1131 that may be quick disconnects to allow fast operation of the unit. A gas line 1133 leads via a line in the cable 972 to the controller module 980 where a vacuum pump not shown can be used to augment gas flow. Typically the pump provides a speed for air through the sampling chamber of about 500 ml per second. Various gases may be used, with PCBs it was determined that ordinary air worked well, however in some situations inert gases may be needed. Thermocouples 1140 are typically used to control and monitor temperatures at the sampling head 910. Heaters 1150 are used to maintain the temperature of the sampling head particularly in the sample collection area to that required to prevent condensation of analyte and thus loss of sensitivity of the unit. The heater provides energy to the optical cavity in the sampling head to drive the temperature to about 230° C. in the case of PCB measurement. The temperature controller is also located in the cart 981 and receives information from/to thermocouples in the sampling head 910. A magnetic holder 1160 may be used to hold the unit to magnetic surfaces thus facilitating measurements.

As sample collection begins the laser pulses sending energy (the dotted line) to the surface that breaks the bonds in the paint releasing vaporized material and small particulate that is then collected in an absorbent trap 1130 The absorbent trap is seen on the top of the sampling head 910 in FIG. 10 and is connected to the pump and the outflow area of the optical cavity. The cavity is heated to about 230° C. which ideally eliminates all deposits on the walls of the chamber and the optical window. Deposits are minimized by the heating of the chamber, and by the flow of the gas that drives the vaporized sample into the absorption trap

Typically there is a hot air flow from preheated inflow openings into the sampling head that sweeps past the area heated by the laser beam and sweeps the gases generated by the heat from the laser beam into an outflow opening to absorption trap where the gases of interest are absorbed or adsorbed onto the inner surface of the trap. A pump in the control module provides the required air flow.

Referring now to FIG. 11, the sample spot is typically heated until a selected volume of paint or other surface has been removed. The absorption trap 1130 is then removed from the sampling head 910 and is placed into thermal desorption unit 1180. The desorbed analyte then flows via line 1181 to analyte measurement unit 1190 which is typically a gas chromatograph 1191 and mass spectrometer 1192. Typical analyzing apparatus includes GC-MS; GC; I.R., infrared, analysis; nuclear techniques, e.g. Geiger counter; etc. A currently preferred test spot size is about 0.01 cm² where the energy density is typically about 40 mJ/pulse. This is about 4000 mJ/cm² and works for typical paints. This spot is scanned across the surface to strip an area of about 3 mmm by 3 mm.

In a preferred embodiment the sample head 910 is connected to the control module 980 by a utility cable that consists of two gas lines for bringing gas flow to the sample head 910 and back out for analysis, two control lines for motion of control of the scanning mirror 1109, two lines for the thermocouples 1140 in the from part of the sampler and power for heaters 1150 in the sampler.

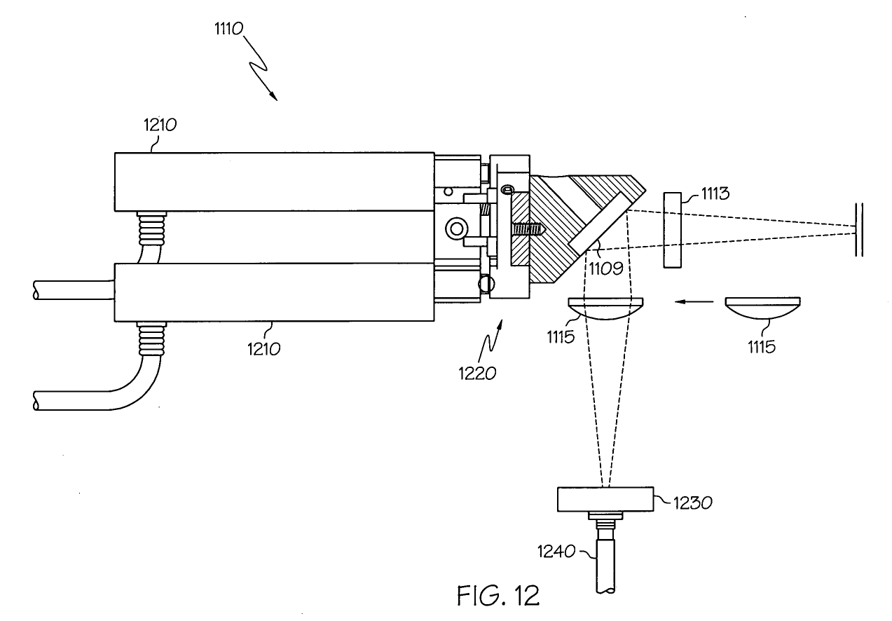

Referring now to FIG. 12, the figure shows the inner schematic view of the optical related components in the sampling head 910. The sampling head consists of components that provide energy to the surface for stripping the top layer containing the impurity, and provides the sample collecting components. In order to reduce the size of the laser needed to provide the proper amount of sample for the analysis, the beam is sequentially scanned over an area on the surface being analyzed. The scanning is accomplished by tilting the mirror 1109 placed in front of a fiber optic tip. The tip directs the energy through a lens which focuses it on the surface. The tilting mirror 1109 is programmed to cover a specified area. The area it covers, depends on the thickness of the paint layer to be analyzed. This is determined by the operator before the sample collection begins.

FIG. 12 details include the mirror control assembly 1110 typically consisting of mirror motion control units 1210 (Newport CMA-12CCCL, Newport U100-A38) a mirror head assembly 1220 (Newport UPA-45D1) holding the mirror 1109 (Newport 10QM2OHM.15). The lens used was a CVI PLCX-25.4-19.6-UV-1064 type. An optical interface 1230 (Oz Optics HPUCO-25-1064-M-4.5AS-SP) was used at the end of the fiber optic cable 1240.

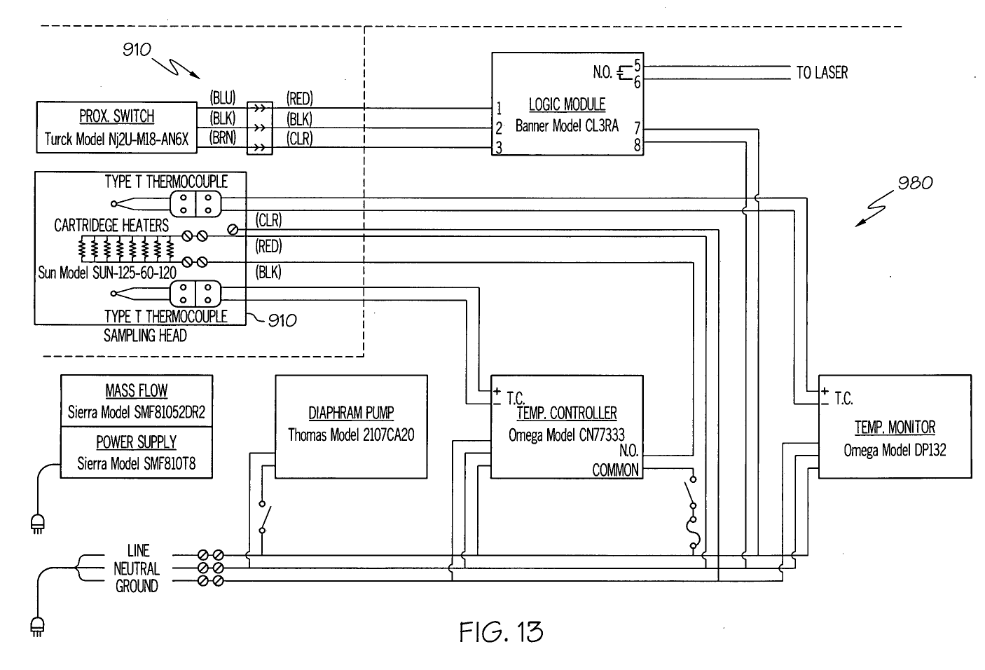

Referring now to FIG. 13, the figure illustrates the electrical and logic connections for control of the sampling head. The figure is generally self explanatory.

Operating Procedures for the Sample Module

In the field, the apparatus is taken to the site of interest and the following steps taken:
1. Measure thickness of the paint. This typically is performed by use of a magnetic sensor made by Electro-phisik, the model minitest 4000. This instrument has heads for both magnetic material subsurfaces and conducting subsurfaces. On non-metallic surfaces the operator might use depth gages or acoustical sensing. The accuracy of the calibration requires this depth determination.
2. Carefully remove the sampling collector assembly (sampling head) from the container and place on site for use. Mount the absorbent trap into position using the quick connect feature. Record the tube identification and sample site identification.
3. Mount the sampling head to the area of interest. If the sampling area is steel or other magnetic material a magnetic holder may be used.
4. Turn on the heating system about 5 minutes before sampling. The heating system is started so that the sampling head is at operating temperature (for PCBs at about 225° C. When moving from site to site this may be already hot.
5 Check that the vacuum pump is turned on.
5. Run the program for controlling the laser and check the homing position of the laser. Calculate the target area=paint volume/thickness of the paint.
6. Typically, a selected volume of paint will be needed for measurement. Typically this is about (2 mm³) Given the target paint volume desired the area to be sampled is determined by the above equation. Choose the area.
7 Run the sampling program which starts the laser Start the Laser
8 Typically the sampling takes about 5 minutes. Remove the absorbent trap. Cap it send it for analysis.
9 Replace the sample head into the controller cart.
10 Move the Sample Module to the next sampling site.
   Typically the process will take about 10 minutes.
   Analysis of the Samples for a preferred Embodiment of Invention

Equipment used in the latest and best embodiment of the Analysis Assembly system is described in the following paragraphs. This system was used to analyze the samples of the latest PCB Sample Analysis Module described above. The Absorbent traps from the Sample Module measurements are transferred to the analysis instrumentation. The data from the absorbent traps and the paint thicknesses and volumes can be combined to show a nominally linear relationship of mass detected and concentration in the paint.

The absorbent traps used are custom made, prepacked, ATD Tubes.(Perkin Elmer type) from Supelco. The tubes are packed with CarboTrap 202., a Carbo Pack B. These tubes are cleaned in a Varian TC oven by precleaning the open tubes for several hours by simple heating to 340 C and by flowing purified nitrogen gas through the tubes for two hours at 100 cc/min at this same temperature. The tubes are thus reuseable.

After the samples are taken to the sampling instrument the absorbent trap brought to the Analysis Instrumentation. The tubes are uncapped and a small piece of glass wool is placed in the tip to prevent small particulate from entering the GC apparatus as the tube is desorbed. The absorbent traps are then were mounted in the Unity Markes Thermal desorber and raised to about 225° C. The desorber was used in split mode (2/1) where the sample for analysis was transferred to the Inlet trap of the Gas chromatograph(GC) system.

The GC system is an HP6890 Series configured with a DB-5MS Column. The column is 60 meters long with an ID of 0.32 mm and a 0.25 micrometer film thickness. The temperature of the column was increased from 30° C. to 220° C. over a 50 minute period this time period. The output from this included PCB materials which were found to have retention times of about 25 minutes to 40 minutes.

The GC is coupled with a Mass Selective Detector an HP 5973 system This system makes frequent measurements of the total mass spectrum at frequent times through out the retention time cycle. Unity Software was used with the HP5973 for control.

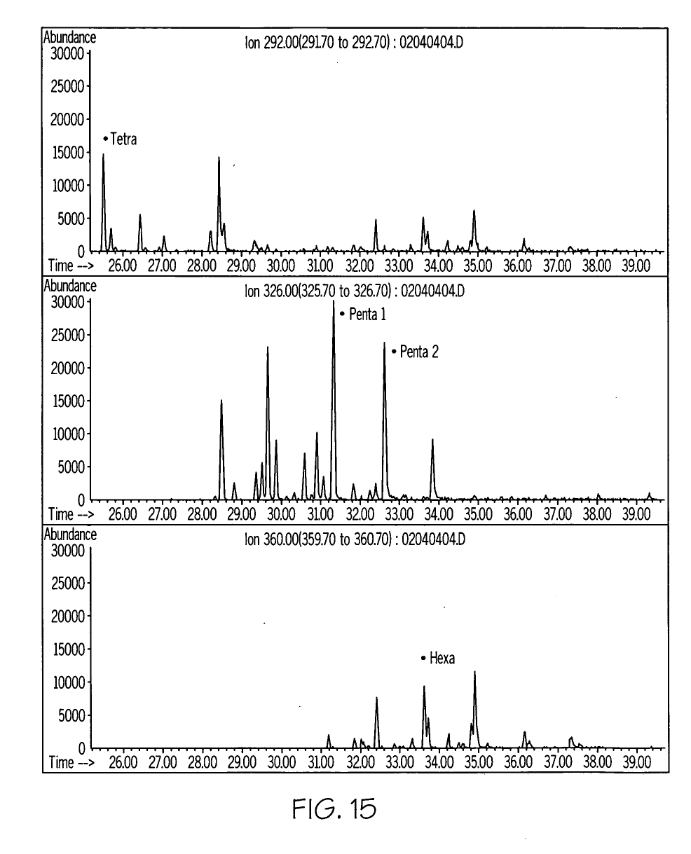

The Chemstation software was used to manipulate the MS output enabling analysis of specific masses for patterns verifying the presence of the PCB cogeners. For example, peaks present at masses 360, 326, 292, 254, 222 are all multiples of the average chlorine isotopic masses. By looking at these ions the recognizable PCB patterns are observed. FIG. 15 shows three examples of these. The output of samples from materials containing PCB were analyzed as containing tetrachlorobiphenyls, pentachlorobiphenyls and hexafluorobiphenyls. FIG. 15 shows a scan of these PCBs identifying the bands used in the materials scans to determine the quantification of the PCBs. Tetra chlorbiphenyls are seen at 25.5 minutes in ion 292, a group of pentachloro cogeners are seen at 31.3 minutes and 32.6 minutes in the ion of 326. The peak at 33.6 minutes contains hexachlorobiphenyl cogeners as shown when looking at ion 360.

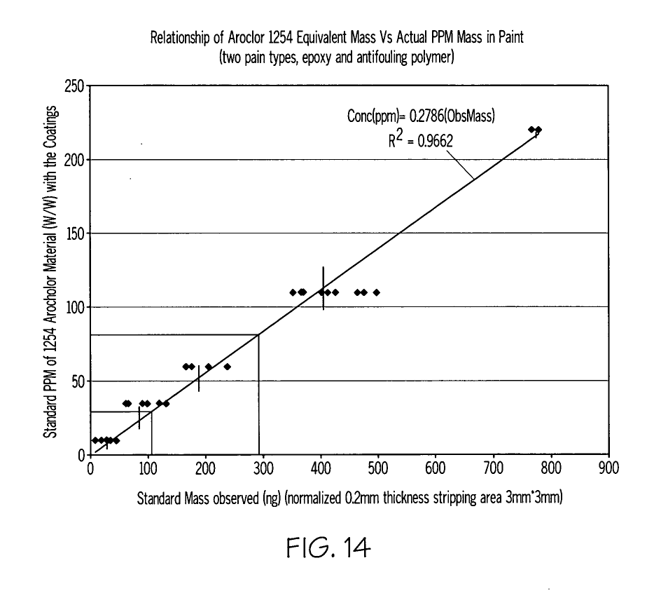

Referring now to FIG. 14, the most recent and preferred embodiment for the invention was used to generate the depicted calibration curve and is shown to indicate the state of the art in the development of the technique. A set of calibration standards were developed in which known amounts of PCB 1254 were mixed with the paint before being applied to the surface The measured masses were combined with an epoxy paint and an anti fouling paint. To generate the data shown here several measurements at 10 ppm, 35 ppm, 60 ppm, and 110 ppm and 210 ppm were made on the paints. Points on this curve were determinations of quantity based on peak areas in bands as shown in FIG. 15 using the four sets of bands representing the tetra, penta and hexa cogeners. Each scan generates four points on the graph. Comparisons of the materials were made against the observations of Pure Aroclor 1254. So that a concentration is determined by its relative band strength to the pure compound. Other controls on the experiments included internal standards such as phenanthrene injection into the tubes.

Referring again to FIG. 14, in these measurements, the errors are in the measured mass for generation of the curve. The projection of these errors on the calibration curve, show the size of the error in ppm expected for a sample when this curve is used. The resulting error blocked out as the indeterminate region in the measurements is two standard deviations of the error bars in the region of interest which is centered at 50 ppm. The EPA allowable standard for calling a sample uncontaminated is at 50 ppm. Using or normalizing to a standard sample size (for example normalized collection volume (2 mm³) of paint), the calibration curve using Aroclor 1254 standards indicated that for both of these paints within measurement error
Detection of less than 100 ng PCB (Equivalent Aroclor 1254) material indicates the sample is clean.
Detection of more than 290 ng of PCB materials indicates the sample is contaminated.

Detection of levels between 100 and 290 ng indicates an indeterminate answer to the categorization of the painted surface. The surface then requires further testing. Either

The suggestion is to

1. Take a second sample on the area. (This might act a tie breaker) OR
2. Send out a sample for standard analysis.
   Note that the standard analysis may actually be no more accurate that this original measurement.

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

1. A sample collector assembly comprising
(i) a frame forming a sampling enclosure with a sampler opening;
(ii) a mirror and lens control assembly mounted to said frame and in communication with said sampling enclosure, for focusing a laser beam onto a sample through said sampler opening and vaporizing an analyte from a sample;
(iii) an absorbent trap mounted to said frame and in communication with said sampling enclosure;
(iv) a gas moving system mounted to said frame for providing a flow of gas to said sampling enclosure for moving vaporized analyte to said absorbent trap;

2. The sample collector assembly according to claim 1, wherein said sample collector includes a quick disconnect for mounting and removal of said absorbent trap.

3. The sample collector assembly according to claim 1, wherein said sample collector includes a magnetic holder for holding the sample collector against a magnetic surface.

4. The sample collector assembly according to claim 1, wherein a heater is mounted to said frame for heating said frame and sampling enclosure.

5. The sample collector assembly according to claim 1, wherein one or more thermocouples are mounted to said frame for controlling temperature in the sample collector assembly.

6. A method for collecting samples for analysis of impurities in or on a sample comprising:
A. irradiating a sample area with laser energy sufficient to vaporize an analyte or break down a material containing an analyte and vaporizing the analyte; and
B. sweeping said vaporized analyte into an absorbent trap.

7. The method according to claim 101, comprising the additional steps of C. placing the absorbent trap into a thermal desorber and heating the absorbent trap to vaporize the analyte; and
D. measuring the vaporized analyte.

8. The method according to claim 102, wherein the vaporized analyte is measured by GC-MS, GC, I.R. analysis or nuclear techniques.
